(19) United States
(12) Patent Application Publication
(10) Pub. No.: US 2013/0132166 A1
(43) Pub. Date: May 23, 2013

(54) SMART TOLL NETWORK FOR IMPROVING PERFORMANCE OF VEHICLE IDENTIFICATION SYSTEMS

(71) Applicants: Wencheng Wu, Webster, NY (US); Edul N. Dalal, Webster, NY (US)

(72) Inventors: Wencheng Wu, Webster, NY (US); Edul N. Dalal, Webster, NY (US)

(73) Assignee: XEROX CORPORATION, Norwalk, CT (US)

(21) Appl. No.: 13/298,949

(22) Filed: Nov. 17, 2011

(51) Int. Cl. G07B 15/02

(52) U.S. Cl. 705/13

(57) ABSTRACT

A smart toll network system for “network-based” analysis via communication of relevant vehicle identifications among to stations (i.e., by forming a smart toll network) coupled with a probabilistic-based search is disclosed. Comparing vehicle identification data (such as license plate recognition and vehicle signatures) between toll stations improves the performance relative to point-based vehicle identification analysis. Of the vehicles unidentified by license plate recognition, vehicle signatures are used to link each of them to the corresponding vehicle at the opposite end of the tolling system. If license plate recognition fails on a vehicle at an exit station, vehicle signatures can be used to find the location where that vehicle entered the tolling system. If license plate recognition was successful at the entrance station, that same license plate number can be assigned to that vehicle at the exit station, on the basis of the vehicle signature matching, without requiring human intervention.

### TECHNICAL FIELD

The disclosed embodiments relate to vehicle tolling systems. The disclosed embodiments further relate to smart toll network system to extend “point-based” vehicle identification analysis to “network-based” analysis. The disclosed embodiments also relate to comparing vehicle identification data between toll stations to improve vehicle identification performance.

### BACKGROUND OF THE INVENTION

Toll roads typically provide a useful and viable means for expediting vehicular traffic by providing controlled toll road access and superior toll road design and construction. In exchange for providing expedited traffic routes, a pertinent governmental authority, quasi-governmental authority or private authority typically assesses a user fee, such as a toll or tariff for toll road use. Tolls collected when crossing roads, bridges, and tunnels often represent a major source of income for many states and municipalities. While toll roads are intended to expedite traffic flow, toll roads are often subject to excessive traffic loads during peak travel times.

Tolling systems can be grouped into two categories: passive and active systems. Active systems require users to carry additional, easily-accessible identification (e.g., E-ZPass®, RFID, etc.). In an active system, some toll systems may require a motorist to rent and attach a radio transponder to the windshield of a motorist's vehicle. The radio transponder communicates via radio frequency with receiver units at tollbooth plazas to automatically collect toll funds from a motorist's account. Such programs require drivers to seek out and register for the program. Many motorists who infrequently travel through the toll road may receive little benefit after investing time and money to participate in the program. A vehicle without the proper transponder equipment may still enter and exit a toll road.

Passive tolling systems do not require additional identification systems attached to or associated with a vehicle. Passive systems commonly consist of two steps: (1) vehicle identification at each relevant toll station, and (2) a high-level often centralized billing system that automatically bills the motorist based on the extracted vehicle identifications from these toll stations, relevant location information, time stamp, etc. Vehicle identification methods can attempt to automatically and accurately identify a large volume of vehicle license plate numbers for easier centralized billing. A substantial volume of vehicles that pass through a typical toll facility typically have too high of an error rate and/or too low of a confidence level for effective identification, requiring manual intervention, which significantly increases the cost of the operation.

Therefore, a need exists for a smart toll network system to significantly improve the accuracy and/or confidence level of automatic vehicle identification. Systems and methods are disclosed for achieving this goal by extending vehicle identification analysis to “network-based” analysis via communication of relevant vehicle identifications among toll stations (i.e., by forming a smart toll network) coupled with a probabilistic-based search.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide for an improved vehicle identification system and method.

It is another aspect of the disclosed embodiments to provide for a smart toll network system to extend “point-based” vehicle identification analysis to “network-based” analysis.

It is a further aspect of the disclosed embodiments to compare vehicle identification data between toll stations to improve vehicle identification performance.

The above and other aspects can be achieved as is now described. A smart toll network system to extend “point-based” vehicle identification analysis to “network-based” analysis via communication of relevant vehicle identifications among toll stations (i.e., by forming a smart toll network) coupled with a probabilistic-based search is disclosed. It is generally necessary to identify vehicles at both entry and exit toll stations in order to determine the amount of the toll. Comparing vehicle identification data, which is based on license plate recognition methods such as Optical Character Recognition (OCR), as well as vehicle signatures, between toll stations improves the performance relative to point-based vehicle identification analysis. Of the vehicles unidentified by license plate recognition, vehicle signatures are used to link each of them to the corresponding vehicle at the opposite end of the tolling system. If license plate recognition fails on a vehicle at an exit station, vehicle signatures can be used to find the location where that vehicle entered the tolling system. If license plate recognition was successful at the entrance station, that same license plate number can be assigned to that vehicle at the exit station, on the basis of the vehicle signature matching, without requiring human intervention.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates an exemplary block diagram of a sample data-processing apparatus, which can be utilized for processing secure data, in accordance with the disclosed embodiments;

FIG. 2 illustrates an exemplary schematic view of a software system including an operating system, application software, and a user interface, in accordance with the disclosed embodiments;

FIG. 3 illustrates an exemplary graphical illustration of absolute vehicle identification comparisons, in accordance with the disclosed embodiments;

FIG. 4 illustrates an exemplary graphical illustration of relative vehicle identification comparisons, in accordance with the disclosed embodiments;

FIG. 5 illustrates an exemplary graphical illustration of relative vehicle identification comparisons for vehicle identification, in accordance with the disclosed embodiments;

FIG. 6 illustrates an exemplary graphical illustration of human inspection for vehicle identification, in accordance with the disclosed embodiments;

FIG. 7 illustrates an exemplary high level flow chart of operations illustrating logical operational steps of a method for identifying a vehicle, in accordance with the disclosed embodiments; and

FIG. 8 illustrates an exemplary table of the probability of success of the vehicle identification system and method (q) as a function of probability of success by the point-based approach (p), in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, one or more of the disclosed embodiments can be embodied as a method, system, or computer program usable medium or computer program product. Accordingly, the disclosed embodiments can in some instances take the form of an entire hardware embodiment, an entire software embodiment or an embodiment combining software and hardware aspects all generally referred to herein as a “module”. Furthermore, the disclosed embodiments may take the form of a computer usable medium, computer program product, a computer-readable tangible storage device storing computer program code, said computer program code comprising program instructions executable by said processor on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The disclosed embodiments are described in part below with reference to flowchart illustrations and/or block diagrams of methods, systems, computer program products, and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

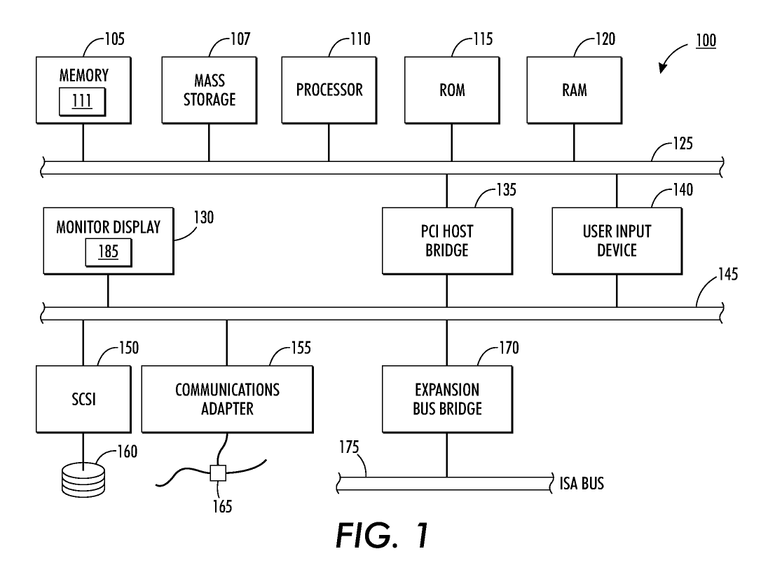

FIG. 1 illustrates a block diagram of a sample data-processing apparatus 100, which can be utilized for an improved vehicle identification method and system. Data-processing apparatus 100 represents one of many possible data-processing and/or computing devices, which can be utilized in accordance with the disclosed embodiments. It can be appreciated that data-processing apparatus 100 and its components are presented for generally illustrative purposes only and do not constitute limiting features of the disclosed embodiments.

As depicted in FIG. 1, a memory 105, a mass storage 107 (e.g., hard disk), a processor (CPU) 110, a Read-Only Memory (ROM) 115, and a Random-Access Memory (RAM) 120 are generally connected to a system bus 125 of data-processing apparatus 100. Memory 105 can be implemented as a ROM, RAM, a combination thereof, or simply a general memory unit. Module 111 includes software module in the form of routines and/or subroutines for carrying out features of the present invention and can be additionally stored within memory 105 and then retrieved and processed via processor 110 to perform a particular task. A user input device 140, such as a keyboard, mouse, or another pointing device, can be connected to PCI (Peripheral Component Interconnect) bus 145. Note that the term “GUI” generally refers to a type of environment that represents programs, files, options, and so forth by means of graphically displayed icons, menus, and dialog boxes on a computer monitor screen.

Data-process apparatus 100 can thus include CPU 110, ROM 115, and RAM 120, which are also coupled to a PCI (Peripheral Component Interconnect) local bus 145 of data-processing apparatus 100 through PCI Host Bridge 135. The PCI Host Bridge 135 can provide a low latency path through which the processor 110 may directly access PCI devices mapped anywhere within bus memory and/or input/output (I/O) address spaces. PCI Host Bridge 135 can also provide a high bandwidth path for allowing PCI devices to directly access RAM 120.

A communications adapter 155, a small computer system interface (SCSI) 150, and an expansion bus-bridge 170 can also be attached to PCI local bus 145. The communications adapter 155 can be utilized for connecting data-processing apparatus 100 to a network 165. SCSI 150 can be utilized to control high-speed SCSI disk drive 160. An expansion bus-bridge 170, such as a PCI-to-ISA bus bridge, may be utilized for coupling ISA bus 175 to PCI local bus 145. Note that PCI local bus 145 can further be connected to a monitor 130, which functions as a display (e.g., a video monitor) for displaying data and information for a user and also for interactively displaying a graphical user interface (GUI).

The embodiments described herein can be implemented in the context of a host operating system and one or more modules. Such modules may constitute hardware modules such as, for example, electronic components of a computer system. Such modules may also constitute software modules. In the computer programming arts, a software “module” can be typically implemented as a collection of routines and data structures that performs particular tasks or implements a particular abstract data type.

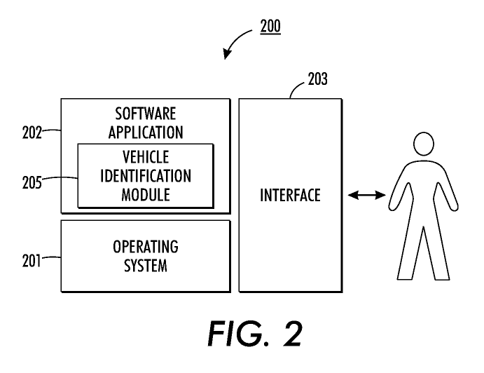

Software modules generally can include instruction media storable within a memory location of an image processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term “module” as utilized herein can therefore generally refer to software modules or implementations thereof. Such modules can be utilized separately or together to form a program product that can be implemented through signal-bearing media, including transmission media and/or recordable media. An example of such a module that can embody features of the present invention is a vehicle identification module 205, depicted in FIG. 2.

It is important to note that, although the embodiments are described in the context of a fully functional data-processing system (e.g., a computer system), those skilled in the art will appreciate that the mechanisms of the embodiments are capable of being distributed as a program product in a variety of forms, and that the present invention applies equally regardless of the particular type of signal-bearing media utilized to actually carry out the distribution. Examples of signal bearing media include, but are not limited to, recordable-type media such as media storage or CD-ROMs and transmission-type media such as analogue or digital communications links.

FIG. 2 illustrates a schematic view of a software system 200 including an operating system, application software, and a user interface for carrying out the disclosed embodiments. Computer software system 200 directs the operation of the data-processing system 100 depicted in FIG. 1. Software application 202, stored in main memory 105 and on mass storage 107, includes a kernel or operating system 201 and a shell or interface 203. One or more application programs, such as software application 202, may be “loaded” (i.e., transferred from mass storage 107 into the main memory 102) for execution by the data-processing system 100. The data-processing system 100 receives user commands and data through the interface 203, as shown in FIG. 2. The user's command input may then be acted upon by the data-processing system 100 in accordance with instructions from operating module 201 and/or application module 202.

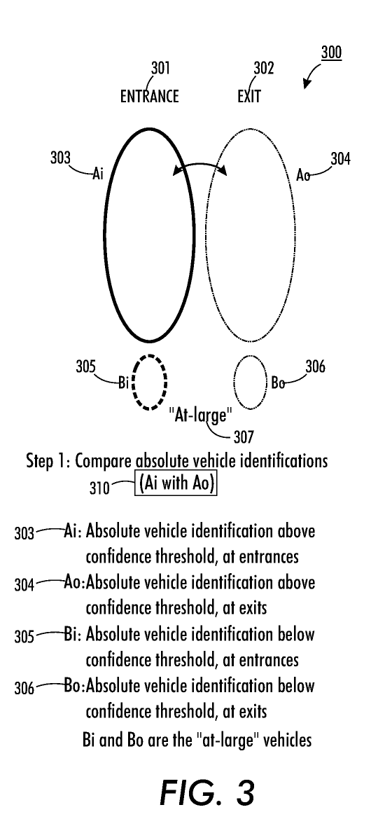

The interface 203 also serves to display printer and/or host computer print job modification results, whereupon the user may supply additional inputs or terminate the session. In an embodiment, operating system 201 and interface 203 can be implemented in the context of a “Windows” system. It can be appreciated, of course, that other types of systems are possible. For example, rather than a traditional “Windows” system, other operation systems such as, for example, Linux may also be employed with respect to operating system 201 and interface 203. The software application 202 can include a vehicle identification module 205 that can be adapted to accurately predict the remaining useful life of a device or device component, as described in greater detail herein. The software application 202 can also be configured to communicate with the interface 203 and various components and other modules and features as described herein. The vehicle identification module 205, in particular, can implement instructions for carrying out, for example, the methods 300, 400, 500, 600, 700, and 800 depicted in FIGS. 3, 4, 5, 6, 7, and 8 respectively, as described below, and/or additional operations as described herein.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program design to assist in the performance of a specific task such as word processing, accounting, inventory management, music program scheduling, etc.

Generally, program modules include routines, programs, objects, components, data structures, etc., that perform particular tasks or implement particular abstract data types. Moreover, those skilled in the art will appreciate that the disclosed method and system may be practiced with other computer system configurations such as, for example, hand-held devices, multi-processor systems, microprocessor-based or programmable consumer electronics, networked PCs, minicomputers, mainframe computers, and the like.

There are interactions among toll stations using the program modules including routines, programs, objects, components, and data structures that can be utilized to improve vehicle identification system performance. Automated License Plate Recognition (“ALPR”) technologies can use a camera and processing algorithms, complemented by human inspection, to identify vehicles. Generally these two steps are loosely coupled, i.e., the toll stations essentially communicate the results (rather than the process of the analyses) to the centralized billing system. As a result, the performance and cost of current systems rely heavily on the performance of computer-aided systems such as ALPR for vehicle identification. The more accurate the computer-aided system, the less human inspection is required, thus reducing labor costs. Because the analysis of ALPR on one toll station does not depend on the other, these ALPR system's are referred to as “point-based” analysis systems. The ALPR system can reside on a server or be distributed among toll stations or servers. “Point-based” analysis can refer to analyzing images of each toll station in isolation.

A smart toll network system to extend “point-based” vehicle identification analysis to “network-based” analysis via communication of relevant vehicle information among toll stations (i.e., by forming a smart toll network) coupled with a probabilistic-based search is disclosed. Vehicle identification methods generally involve absolute vehicle identification or relative vehicle identification or both. Here, absolute vehicle identification refers to an identification that would uniquely identify a vehicle, for example, the alphanumeric information on a license plate is a unique ID for identifying a vehicle. Relative vehicle identification, on the other hand, refers to identification of matching pairs of vehicles from different groups, using information such as vehicle size, shape and color, make and model, and unique elements such as bumper stickers and body damage, etc.

Both absolute and relative identifications can be made with varying levels of confidence. A valid identification is one where the confidence exceeds some threshold value. This required threshold value may be different for absolute and relative identifications. An example of absolute vehicle identification is license plate recognition (i.e., determination of the alphanumeric characters on a license plate) and a typical way of achieving this is by OCR (i.e., “Optical Character Recognition”). Relative vehicle identification can include, for example, finding a blue Ford® pickup truck that enters and exits a toll road on a given date, with a reasonable length of time between the entry and exit. One of the key novel characteristics of this invention is how relative identification is utilized in a toll network. Hence, more examples will be discussed later.

For example, vehicles enter a toll highway at one of the many entry points and leave at one of the many exit points. Images (e.g., still or video) are taken of the vehicles at these points. These images and their corresponding vehicle information can form a database for entrance (Ai+Bi, see FIG. 3) and for exit (Ao+Bo). Here, “+” refers to union of the data set. Within the databases, the bulk of vehicles are successfully identified via absolute identification (e.g., OCR on the license plate images with confident results) at entrances and/or exits of the travel segment (Ai and Ao in FIG. 3, which are generally much larger than Bi and Bo unless a very poor ALPR system is used). The remaining (i.e., unidentified) vehicles at entrances and exits, called the “at-large” vehicles, are denoted as Bi and Bo, respectively. Current “point-based” system would introduce costly manual inspection for vehicles in Bi and Bo in an attempt to further improve absolute vehicle identification, i.e., to move them into Ai and Ao as much as possible by manual inspection. Tolls would be billed from successfully paired absolute vehicle identifications and the unpaired vehicles would be ignored.

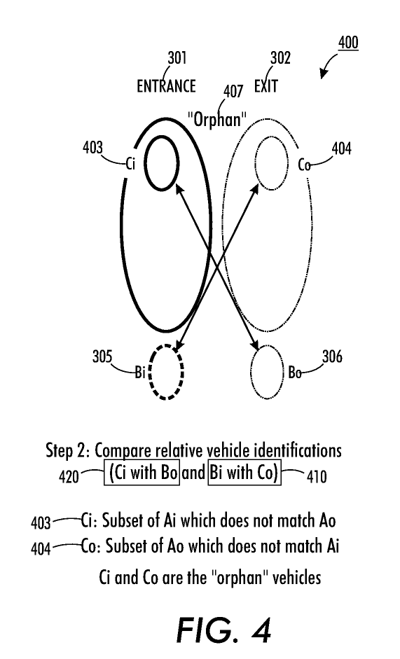

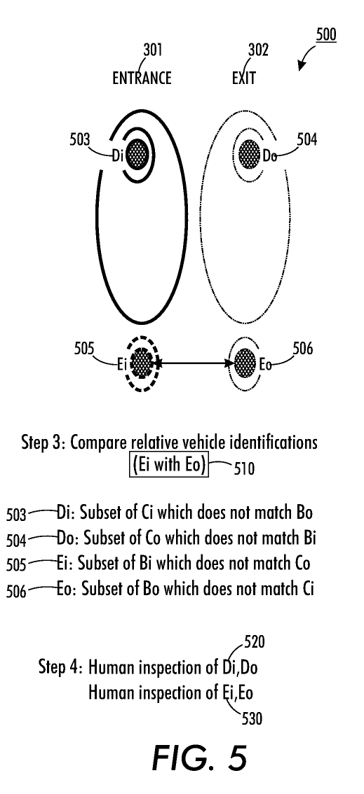

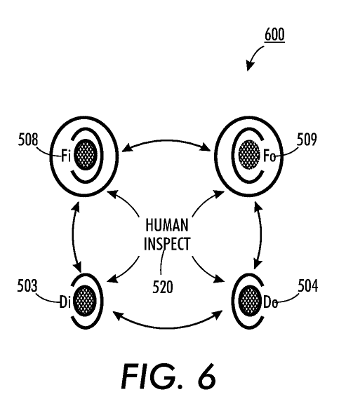

“Network-based” method proposed here will perform much better. The bulk of the vehicles will be successfully identified at both ends of the travel segment (i.e., the successful pairing among Ai and Ao) and these vehicles do not need further consideration. For the remaining vehicles that have not been successfully paired at this stage, an intelligent communication of relevant vehicle information is sent among toll stations to improve upon the “point-based” method. In particular, the vehicle identification process for vehicles entering and exiting a toll road travel segment can comprise four steps: comparing absolute vehicle identifications (FIG. 3) of vehicles at entry and exit stations; comparing relative vehicle identifications (FIG. 4) of vehicles not matched in the previous step; further comparing relative vehicle identifications of unmatched at-large vehicles (FIG. 5); and human inspection of remaining vehicle identification data (FIG. 6).

FIG. 3 illustrates an exemplary graphical illustration 300 of absolute vehicle identification comparisons 310, in accordance with the disclosed embodiments. The vehicle identification process begins with comparisons between the sets with successful absolute vehicle identifications (i.e., Ai 303, Ao 304). Here, successful absolute vehicle identification refers to uniquely identifying a vehicle above a confidence threshold (e.g., OCR on the license plate images with confident results). For example, an absolute vehicle identification above a confidence threshold (i.e., Ai 303) can be made at an entrance 301 of a toll road. Likewise, an absolute vehicle identification above a confidence threshold (i.e., Ao 304) can be made when a vehicle exits 302 a toll road. The unique vehicle information (e.g., alphanumerical information of the license plate) of the successfully identified vehicles (Ai 303 and Ao 304) are compared 310 to determine matching vehicle identifications. At this stage, matching need not include the use of relative vehicle identifications, for example, comparing make, model, type, and color of the vehicle, etc. A matched absolute vehicle identification results in a positively identified vehicle for toll road fee collection and management. Unmatched vehicles in Ai 303 and Ao 304 are considered as “orphan” vehicles which are labeled as Ci 403 and Co 404, and are further described in FIG. 4.

For those vehicle identifications Bi 305, Bo 306, where the absolute vehicle identification of those vehicles fails to be made above a confidence threshold (i.e., the sets with unsuccessful absolute vehicle identification), the identification features can be stored in a database 307 for further assessment. For example, an absolute vehicle identification may fail to be made above a confidence threshold (i.e., Bi 305) at an entrance 301 of a toll road. Likewise, an absolute vehicle identification may fail to be made above a confidence threshold (i.e., Bo 306) when a vehicle exits 302 a toll road. Identification results 305, 306 are then stored in a database 307.

FIG. 4 illustrates an exemplary graphical illustration 400 of relative vehicle identification comparisons 410, 420, in accordance with the disclosed embodiments. The vehicle identifications Bi 305 and Bo 306 that are stored in the database 307 can then be compared with “orphan” vehicle identifications 407, Ci 403 and Co 404. Orphan vehicles 407 are those where absolute vehicle identification succeeds above a confidence threshold at either an entrance 301 or exit 302, but a vehicle match cannot be found at either the exit 302 or entrance 301, respectively. Orphan vehicle identification set Ci 403 is a subset of Ai 303 which does not match Ao 304. Orphan vehicle set Co 404 is a subset of Ao 304 which does not match Ai 303.

Orphan vehicle set Ci 403 is compared 420 with identification features of Bo 306, or the set of unsuccessful absolute vehicle identifications gathered at an exit 302, and stored in database 307. The relevant vehicle information such as, for example, plate image, vehicle make and model, vehicle color and type, etc., of the orphan vehicle set Co 404 is compared 410 with relevant vehicle information, for example, plate image, vehicle make and model, vehicle color and type, etc., of Bi 305, which is the set of unsuccessful absolute vehicle identifications gathered at an entrance 301, and stored in database 307. Any vehicles that remain unidentified after these comparisons 410, 420, which are labeled as Di 503, Do 504, Ei 505, Eo 506, are further compared as described in FIGS. 5 and 6.

FIG. 5 illustrates an exemplary graphical illustration 500 of relative vehicle identification comparisons 510 for vehicle identification, in accordance with the disclosed embodiments. Remaining unpaired vehicles in the set with successful absolute vehicle identification at an entrance 301 are gathered in subset Di 503. Di 503 is a subset of Ci 403 that does not match Bo 306. Remaining unpaired vehicles in the set with successful absolute vehicle identification at an exit 302 are gathered in subset Do 504. Do 504 is a subset of Co 404 that does not match Bi 305. Remaining unpaired vehicles in the set of unsuccessful absolute vehicle identification at an entrance 301 are gathered in subset Ei 505 within the database 307. Ei 505 is a subset of Bi 305 that does not match Co 404. Remaining unpaired vehicles in the set of unsuccessful absolute vehicle identification at an exit 302 are gathered in subset Eo 506. Eo 506 is a subset of Bo 306 that does not match Ci 403. Note that data sets in Di 503, Do 504, Ei 505, Eo 506 are typically much smaller in comparison to Ci 403, Co 404, Bi 305, Bo 306, respectively. Hence, one exemplary embodiment introduces human inspection of vehicles in vehicle sets Di 503, Do 504, Ei 505, and Eo 506 to further improve the identification performance.

In an embodiment, vehicles are further compared 510 in Ei 505 and Eo 506 (Step 3 in FIG. 5) via relative vehicle identification (e.g., matching plate images, vehicle make and model, colors, etc.). The remaining unpaired vehicles in Ei 505 and Eo 506 will be saved in subsets Fi 508 and Fo 509, respectively, as further described in FIG. 6. One round of human inspection 520 is still needed for the successful pairings of Ei 505 and Eo 506 because these pairings still lack an absolute vehicle identification. However, since these vehicles have already been paired, only one absolute vehicle identification is needed for each pair of vehicles, thereby reducing the human inspection effort.

FIG. 6 illustrates an exemplary graphical illustration 600 of human inspection 520 (i.e., manually reading out alphanumerical information of a plate by human inspection of acquired plate images one at a time) for vehicle identification, in accordance with the disclosed embodiments. To further improve the identification performance of the disclosed embodiments, human inspection of Di 503, Do 504, Fi 508, and Fo 509 can be initiated. Vehicle pairing by human inspection can be assisted computationally by narrowing the choices presented to the inspector, using clues such as: a reasonable time difference between entry and exit, based on plausible limits to vehicle speed (e.g., less than 200 mph) and direction (on divided highways); partial recognition of vehicle license plates, etc.

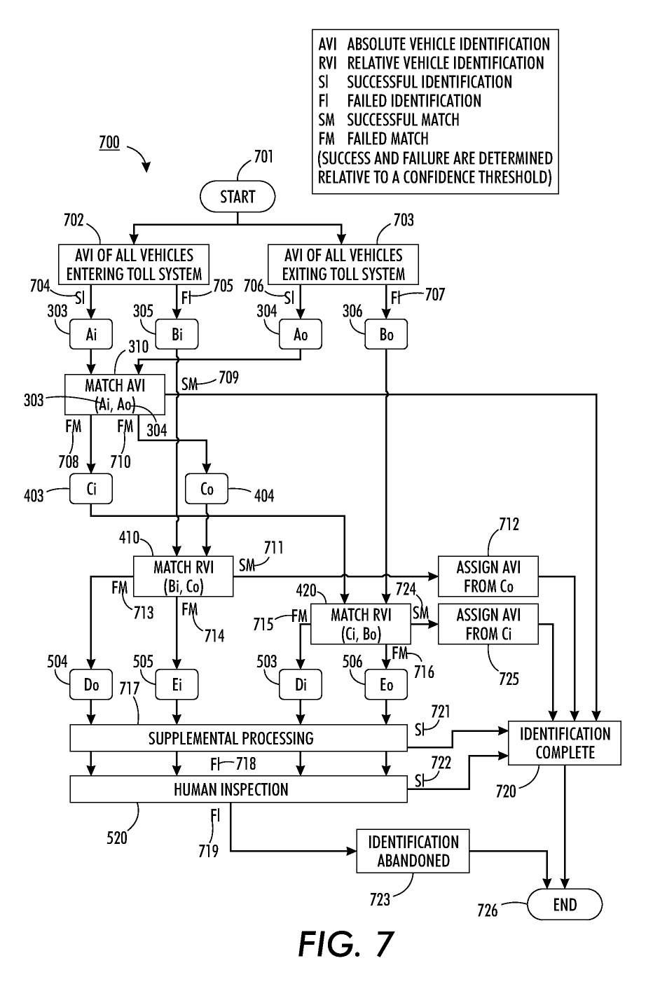

FIG. 7 illustrates an exemplary high level flow chart 700 of operations illustrating logical operational steps for identifying a vehicle, in accordance with the disclosed embodiments. The vehicle identification process starts at block 701 when a vehicle travels through a travel segment of a toll road. The vehicle identification system attempts to make absolute vehicle identifications (i.e., AVI) of all vehicles entering the toll road, as illustrated in block 702, as well as exiting the toll road, as illustrated in block 703. A successful identification (i.e., SI) 704, 706 is an absolute vehicle identification above confidence thresholds, at entrances (i.e., Ai 303) and at exits (i.e., Ao 304). After the AVI is gathered for Ai 303 and Ao 304, the vehicle identification data for Ai 303 and Ao 304 are compared to find matching pairs, as illustrated in block 310. For those vehicles where a successful match 709 of vehicle identification data is made between Ai 303 and Ao 304, the identification process is complete, as illustrated in block 720, and the vehicle identification process ends, as illustrated in block 726. For those vehicles in Ai 303 where the comparison of vehicle identification data fails 708, the unpaired vehicles from Ai 303 are stored in an orphan vehicle database as subset Ci 403. For those vehicles in Ao 304 where the comparison of vehicle signatures and vehicle identification data fails 710, the unpaired vehicles from Ao 304 are stored in an orphan vehicle database as subset Co 404.

For those vehicles in Bi 305, where the AVI of vehicles entering 702 the toll system has failed 705, Bi 305 is compared to Co 404 to match vehicle signatures, as illustrated in block 410. Note that using of vehicle signatures refers to relative vehicle identification (i.e., RVI). If the signature matching between Bi 305 and Co 404 is successful 711, an AVI is assigned to the pair of matched vehicles from Co 404, as illustrated in block 712. For those vehicles in Co 404 where the signature matching 410 fails 713, the unpaired vehicles from Co 404 are saved in Do 504, which is the subset of Co 404 vehicles in the database that do not match Bi 305. For those vehicles in Bi 305 where the signature matching 410 fails 714, the unpaired vehicles from Bi 305 are saved in Ei 505, which is the subset of Bi 305 vehicles in the database that do not match Co 404.

Similar to the process described above for Bi 305, for those vehicles in Bo 306, where the AVI of vehicles exiting 703 the toll system has failed 707, Bo 306 is compared to Ci 403 to match vehicle signatures, as illustrated in block 420. If the signature matching between Bo 306 and Ci 403 is successful 724, an AVI is assigned to the pair of matched vehicles from Ci 403, as illustrated in block 725. For those vehicles in Bo 306 where the signature matching 420 fails 716, the unpaired vehicles from Bo 306 are saved in Eo 506, which is the subset of Bo 306 vehicles in the database that do not match Ci 403. For those vehicles in Ci 403 where the signature matching 420 fails 715, the unpaired vehicles from Ci 403 are saved in Di 503, which is the subset of Ci 403 vehicles in the database that do not match Bo 306.

Thereafter, the vehicle identification data for Do 504, Ei 505, Di 503, and Eo 506 undergoes supplemental processing, as illustrated in block 717. The supplemental processing 717 may include comparing partial recognition of vehicle license plates, vehicle identification data, and signatures of Di 503 with Eo 506 or Do 504 with Ei 505 or Ei 505 with Eo 506. If the supplemental processing results in successful identification 721 of a vehicle, the identification process are complete, as illustrated in block 720 and the vehicle identification process ends for that vehicle, as illustrated in block 726. Thereafter, the vehicle identification data for those vehicles in Do 504, Ei 505, Di 503, and Eo 506, which failed identification 718 and/or matching in the supplemental processing stage 717, are routed to human inspection 520 of vehicle identification data and signatures, as illustrated in block 520. If human inspection 520 of these vehicles results in successful identification and/or matching 722 of a vehicle, the identification process is complete for that vehicle, as illustrated in block 720 and the vehicle identification process ends, as illustrated in block 726. If human inspection 520 of these vehicles results in a failed identification and/or matching 719 of a vehicle, the identification process is abandoned for that vehicle, as illustrated in block 723 and the vehicle identification process ends, as illustrated in block 726.

Because this invention explores logical interrelationships among toll stations as discussed above, there are various additional considerations that can be incorporated into the embodiments to improve efficiency, performance, and accuracy. Some examples are disclosed in the following paragraphs.

When searching for matching vehicles, the probability of the entrance-to-exit relationships can be used to speed up the process. The following rules may be applied to eliminate the vast majority of possible comparisons and thereby significantly reduce the computational and/or inspection effort:

All vehicles fully accounted for (i.e., identified at both entrance and exit, which will typically be the majority of all vehicles using the tolling system) can be excluded from the comparisons.

In systems with one-way traffic (e.g., typical systems on toll highways), exits that are located before the entrance can be excluded.

Vehicles that exited the tolling system earlier than the subject vehicle entered can be excluded.

Time/distance considerations can be applied. For example, there is no need to compare with vehicles that exit one minute later at a toll station located fifteen miles later.

Entrance-exit pairs with higher historical probabilities of matching pairs can be searched first.

If license plate recognition fails for matched vehicle at both entrance and exit stations, but a partial plate recognition is possible at each station, it is possible that all the license plate characters can be confidently recognized by combining the recognition results from the two stations.

It can be mathematically demonstrated that the probability of successfully identifying a vehicle by this invention is significantly greater than by the point-based approach, for systems with identical sensors and sensing conditions. If the probability of successful identification by the point-based approach is p, the probability of successful identification by this invention is given by q:

q=1−(1−p)²

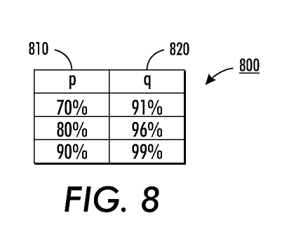

FIG. 8 illustrates a table 800 of the probability of success of the disclosed vehicle identification system and method (q) 820 as a function of probability of success by the conventional point-based approach (p) 810, in accordance with the disclosed embodiments. The significantly improved probability of success results in less human intervention, thereby drastically reducing labor costs. Alternatively, higher vehicle speeds may be permitted through the toll stations, or cheaper hardware systems (e.g., cameras) can be utilized, without any loss of identification performance.

In order to improve signature matching, it may be helpful to correct the images used in determining vehicle signatures for inter-station differences which arise from differences in sensor location and configuration, sensor characteristics, etc. In particular, the differences in geometric perspective between toll stations (e.g., due to different angle of view) can be determined and corrected. The required corrections can be determined by manual input for each toll station at the time of set-up, or by learning from a sub-set of identification comparisons where license plate recognition successfully identified the vehicles at both entrance and exit. Other factors such as optical blur of the sensors, differences in illumination non-uniformity, etc., can also be corrected in a similar fashion and used for correcting inter-station image differences.

Based on the foregoing, it can be appreciated that varying embodiments are disclosed herein, including preferred and alternative embodiments. For example, in one embodiment, method for vehicle identification and toll computation for a vehicle having travelled on a toll road can be implemented. Such a method can include, for example, performing absolute vehicle identifications of vehicles entering the toll road, performing absolute vehicle identifications of vehicles exiting the toll road, pairing successful absolute vehicle identifications of the vehicles entering the toll road and successful absolute vehicle identifications of the vehicles exiting the toll road, using signature matching to pair the vehicles entering the toll road and the vehicles exiting the toll road for some or all remaining unpaired vehicles, and assigning absolute vehicle identifications and computing tolls on a basis of the parings.

In other embodiments, absolute vehicle identifications comprise recognizing license plates of the vehicles. In another embodiment, signature matching comprises matching at least one of: makes of the vehicles, models of the vehicles, body types of the vehicles, colors of the vehicles, body conditions of the vehicles, captured partial image data of the vehicles, captured full image data of the vehicles, and partial license plate recognition of the vehicles. In another embodiment, successful absolute vehicle identifications of the vehicles comprise absolute vehicle identifications with a confidence level above a pre-defined confidence threshold.

In still another embodiment, using signature matching to pair the vehicles entering the toll road and the vehicles exiting the toll road for some or all remaining unpaired vehicles further comprises: for each signature-matched pair of the vehicles where the absolute vehicle identification was successful for one vehicle of the signature matched pair but unsuccessful for the other vehicle of the signature-matched pair, an operation can be implemented for assigning the successful absolute vehicle identification to the pair. In another embodiment, using signature matching to pair the vehicles entering the toll road and the vehicles exiting the toll road for some or all remaining unpaired vehicles further comprises: for each signature matched pair of the vehicles where the absolute vehicle identification was unsuccessful for both vehicles of the signature-matched pair, doing one of the following: performing absolute vehicle identifications of the signature-matched pair via human inspection, or deriving absolute vehicle identifications of the signature-matched pair via analysis of partial license plate recognition data.

In yet other embodiments, using signature matching to pair the vehicles entering the toll road and the vehicles exiting the toll road for some or all remaining unpaired vehicles further comprises: for remaining unpaired vehicles where the absolute vehicle identification was unsuccessful, performing absolute vehicle identification via human inspection and pairing the successful absolute vehicle identifications of the remaining unpaired vehicles. In yet another embodiment, using signature matching to pair the vehicles entering the toll road and the vehicles exiting the toll road for some or all remaining unpaired vehicles further comprises prioritizing the vehicles for signature matching, wherein prioritizing is based on at least one of: relative locations where the vehicles enter the toll road and exit the toll road, the time when the vehicles enter the toll road and exit the toll road, anticipated maximum speed of the vehicles, and anticipated minimum speed of the vehicles.

In other embodiments, a system can be implemented for vehicle identification and toll computation for a vehicle having travelled on a toll road. Such a system can include, for example, a processor, a data bus coupled to the processor, and a computer-usable tangible storage device storing computer program code, the computer program code comprising program instructions executable by the processor. The program instructions can include program instructions to perform absolute vehicle identifications of vehicles entering the toll road, program instructions to perform absolute vehicle identifications of vehicles exiting the toll road, program instructions to pair successful absolute vehicle identifications of the vehicles entering the toll road and successful absolute vehicle identifications of the vehicles exiting the toll road, program instructions to use signature matching to pair the vehicles entering the toll road and the vehicles exiting the toll road for some or all remaining unpaired vehicles, and program instructions to assign absolute vehicle identifications and computing tolls on a basis of the parings.

In yet other embodiments, absolute vehicle identifications comprise recognizing license plates of the vehicles. In some embodiments, signature matching comprises matching at least one of: makes of the vehicles, models of the vehicles, body types of the vehicles, colors of the vehicles, body conditions of the vehicles, captured partial image data of the vehicles, captured full image data of the vehicles, and partial license plate recognition of the vehicles. In other embodiments of such a system, successful absolute vehicle identifications of the vehicles comprise absolute vehicle identifications with a confidence level above a pre-defined confidence threshold.

In still other embodiments, using signature matching to pair the vehicles entering the toll road and the vehicles exiting the toll road for some or all remaining unpaired vehicles further comprises: for each signature-matched pair of the vehicles where the absolute vehicle identification was successful for one vehicle of the signature matched pair but unsuccessful for the other vehicle of the signature-matched pair, program instructions configured to assign the successful absolute vehicle identification to the pair. In yet other embodiments, using signature matching to pair the vehicles entering the toll road and the vehicles exiting the toll road for some or all remaining unpaired vehicles further comprises: for each signature matched pair of the vehicles where the absolute vehicle identification was unsuccessful for both vehicles of the signature-matched pair, providing one of the following: program instructions configured to assist absolute vehicle identifications of the signature-matched pair via human inspection, or program instructions configured to derive absolute vehicle identifications of the signature-matched pair via analysis of partial license plate recognition data.

In another embodiment of the system, using signature matching to pair the vehicles entering the toll road and the vehicles exiting the toll road for some or all remaining unpaired vehicles further comprises: for remaining unpaired vehicles where the absolute vehicle identification was unsuccessful, program instructions configured to assist absolute vehicle identification via human inspection, and program instructions configured to pair the successful absolute vehicle identifications of the remaining unpaired vehicles. In yet other embodiments, using signature matching to pair the vehicles entering the toll road and the vehicles exiting the toll road for some or all remaining unpaired vehicles further comprises prioritizing the vehicles for signature matching, wherein prioritizing is based on at least one of: relative locations where the vehicles enter the toll road and exit the toll road, the time when the vehicles enter the toll road and exit the toll road, anticipated maximum speed of the vehicles, and anticipated minimum speed of the vehicles.

In still another embodiment, a computer-usable tangible storage device storing computer program code can be implemented with the computer program code comprising program instructions executable by a processor. The program instructions can include program instructions to perform absolute vehicle identifications of vehicles entering a toll road, program instructions to perform absolute vehicle identifications of vehicles exiting the toll road, program instructions to pair successful absolute vehicle identifications of the vehicles entering the toll road and successful absolute vehicle identifications of the vehicles exiting the toll road, program instructions to use signature matching to pair the vehicles entering the toll road and the vehicles exiting the toll road for some or all remaining unpaired vehicles, and program instructions to assign absolute vehicle identifications and computing tolls on a basis of the parings.

In another embodiment of such a device, signature matching comprises program instructions to match at least one of: makes of the vehicles, models of the vehicles, body types of the vehicles, colors of the vehicles, body conditions of the vehicles, captured partial image data of the vehicles, captured full image data of the vehicles, and partial license plate recognition of the vehicles. In yet other embodiments of such a device, successful absolute vehicle identifications of the vehicles comprise absolute vehicle identifications with a confidence level above a pre-defined confidence threshold.

In still other embodiments of such a device, using signature matching to pair the vehicles entering the toll road and the vehicles exiting the toll road for some or all remaining unpaired vehicle further comprises at least one of: for each signature-matched pair of the vehicles where the absolute vehicle identification was successful for one vehicle of the signature matched pair but unsuccessful for the other vehicle of the signature-matched pair, program instructions configured to assign successful absolute vehicle identification to the pair; for each signature matched pair of the vehicles where the absolute vehicle identification was unsuccessful for both vehicles of the signature-matched pair, providing one of the following: program instructions configured to perform absolute vehicle identifications of the signature-matched pair via human inspection; or program instructions configured to derive absolute vehicle identifications of the signature-matched pair via analysis of partial license plate recognition data; for remaining unpaired vehicles where the absolute vehicle identification was unsuccessful, program instructions configured to assist absolute vehicle identification via human inspection; program instructions configured to pair the successful absolute vehicle identifications of the remaining unpaired vehicles; and prioritizing vehicles for signature matching based on at least one of: relative locations where the vehicles enter the toll road and exit the toll road, the time when the vehicles enter the toll road and exit the toll road, anticipated maximum speed of the vehicles, and anticipated minimum speed of the vehicles.

It will be appreciated that variations of the above-disclosed and other features and functions, or alternatives thereof, may be desirably combined into many other different systems or applications. Furthermore, various presently unforeseen or unanticipated alternatives, modifications, variations or improvements therein may be subsequently made by those skilled in the art which are also intended to be encompassed by the following claims.

1. A method for vehicle identification and toll computation for a vehicle having travelled on a toll road, comprising:
performing absolute vehicle identifications of vehicles entering said toll road utilizing an automated license plate recognition system;
performing absolute vehicle identifications of vehicles exiting said toll road utilizing said automated license plate recognition system;
pairing successful said absolute vehicle identifications of said vehicles entering said toll road and successful said absolute vehicle identifications of said vehicles exiting said toll road;
creating a set of unpaired vehicles wherein said unpaired vehicles are one of the following: 1) a successful absolute identification vehicle at an entrance of said toll road without a corresponding successful absolute identification at an exit of said toll road, 2) a successful absolute identification vehicle at said exit of said toll road without a corresponding successful absolute identification at said entrance of said toll road or 3) an unsuccessful absolute identification vehicle at either said entrance or said exit of said toll road;
matching said unpaired vehicles using signature matching to pair said successful absolute identification vehicles with said unsuccessful absolute identification vehicles wherein said signature matching identifies said unpaired vehicles utilizing non-optical character recognition of said unpaired vehicles; and
assigning absolute vehicle identifications to said unsuccessful absolute identification vehicles if matched with one of said successful absolute identification vehicles and computing tolls on a basis of said parings.

2. The method of claim 1, wherein absolute vehicle identifications comprise recognizing license plates of said vehicles.

3. The method of claim 1, wherein signature matching comprises matching at least one of: makes of said vehicles, models of said vehicles, body types of said vehicles, colors of said vehicles, body conditions of said vehicles, captured partial image data of said vehicles, and captured full image data of said vehicles.

4. The method of claim 1, wherein successful said absolute vehicle identifications of said vehicles comprise absolute vehicle identifications with a confidence level above a pre-defined confidence threshold.

5. (canceled)

6. The method of claim 1, wherein using signature matching to pair said vehicles entering said toll road and said vehicles exiting said toll road for some or all remaining unpaired vehicles further comprises:
for each signature matched pair of said vehicles where said absolute vehicle identification was unsuccessful for both vehicles of said signature-matched pair, performing absolute vehicle identifications of said signature-matched pair via human inspection.

7. The method of claim 1, wherein using signature matching to pair said vehicles entering said toll road and said vehicles exiting said toll road for some or all remaining unpaired vehicles further comprises:
for remaining unpaired vehicles where said absolute vehicle identification was unsuccessful, performing absolute vehicle identification via human inspection; and
pairing said successful absolute vehicle identifications of said remaining unpaired vehicles.

8. The method of claim 1, wherein using signature matching to pair said vehicles entering said toll road and said vehicles exiting said toll road for some or all remaining unpaired vehicles further comprises prioritizing said vehicles for signature matching, wherein:
said prioritizing is based on at least one of: relative locations where said vehicles enter said toll road and exit said toll road, the time when said vehicles enter said toll road and exit said toll road, anticipated maximum speed of said vehicles, and anticipated minimum speed of said vehicles.

9. A system for vehicle identification and toll computation for a vehicle having travelled on a toll road, comprising:
a processor;
a data bus coupled to said processor; and
a computer-usable tangible storage device storing computer program code, said computer program code comprising program instructions executable by said processor, said program instructions comprising:
program instructions to perform absolute vehicle identifications of vehicles entering said toll road;
program instructions to perform absolute vehicle identifications of vehicles exiting said toll road;
program instructions to pair successful said absolute vehicle identifications of said vehicles entering said toll road and successful said absolute vehicle identifications of said vehicles exiting said toll road;
program instructions to create a set of unpaired vehicles wherein said unpaired vehicles are one of the following: 1) a successful absolute identification vehicle at an entrance of said toll road without a corresponding successful absolute identification at an exit of said toll road, 2) a successful absolute identification vehicle at said exit of said toll road without a corresponding successful absolute identification at said entrance of said toll road or 3) an unsuccessful absolute identification vehicle at either said entrance or said exit of said toll road;
program instructions to use signature matching to pair said successful absolute identification vehicles wherein said signature matching identifies said unpaired vehicles utilizing non-optical character recognition of said unpaired vehicles; and
program instructions to assign absolute vehicle identifications to said unsuccessful absolute identification vehicles if matched with one of said successful absolute identification vehicles and computing tolls on a basis of said parings.

10. The system of claim 9, wherein absolute vehicle identifications comprise recognizing license plates of said vehicles.

11. The system of claim 9, wherein signature matching comprises matching at least one of: makes of said vehicles, models of said vehicles, body types of said vehicles, colors of said vehicles, body conditions of said vehicles, captured partial image data of said vehicles, and captured full image data of said vehicles.

12. The system of claim 9, wherein successful said absolute vehicle identifications of said vehicles comprise absolute vehicle identifications with a confidence level above a pre-defined confidence threshold.

13. (canceled)

14. The system of claim 9, wherein using signature matching to pair said vehicles entering said toll road and said vehicles exiting said toll road for some or all remaining unpaired vehicles further comprises:
for each signature matched pair of said vehicles where said absolute vehicle identification was unsuccessful for both vehicles of said signature-matched pair, program instructions to assist absolute vehicle identifications of said signature-matched pair via human inspection.

15. The system of claim 9, wherein using signature matching to pair said vehicles entering said toll road and said vehicles exiting said toll road for some or all remaining unpaired vehicles further comprises:
for remaining unpaired vehicles where said absolute vehicle identification was unsuccessful, program instructions to assist absolute vehicle identification via human inspection; and
program instructions to pair said successful absolute vehicle identifications of said remaining unpaired vehicles.

16. The system of claim 9, wherein using signature matching to pair said vehicles entering said toll road and said vehicles exiting said toll road for some or all remaining unpaired vehicles further comprises prioritizing said vehicles for signature matching, wherein:
said prioritizing is based on at least one of: relative locations where said vehicles enter said toll road and exit said toll road, the time when said vehicles enter said toll road and exit said toll road, anticipated maximum speed of said vehicles, and anticipated minimum speed of said vehicles.

17. A computer-usable tangible non-transitory storage device storing computer program code, said computer program code comprising program instructions executable by a processor, said program instructions comprising:
program instructions to perform absolute vehicle identifications of vehicles entering a toll road;
program instructions to perform absolute vehicle identifications of vehicles exiting said toll road;
program instructions to pair successful said absolute vehicle identifications of said vehicles entering said toll road and successful said absolute vehicle identifications of said vehicles exiting said toll road;
program instructions to create a set of unpaired vehicles wherein said unpaired vehicles are one of the following: 1) a successful absolute identification vehicle at an entrance of said toll road without a corresponding successful absolute identification at an exit of said toll road, 2) a successful absolute identification vehicle at said exit of said toll road without a corresponding successful absolute identification at said entrance of said toll road or 3) an unsuccessful absolute identification vehicle at either said entrance or said exit of said toll road;
program instructions to use signature matching to pair said successful absolute identification vehicles wherein said signature matching identifies said unpaired vehicles utilizing non-optical character recognition of said unpaired vehicles; and
program instructions to assign absolute vehicle identifications to said unsuccessful absolute identification vehicles if matched with one of said successful absolute identification vehicles and computing tolls on a basis of said parings.

18. The computer-usable tangible storage device of claim 17, wherein signature matching comprises program instructions to match at least one of: makes of said vehicles, models of said vehicles, body types of said vehicles, colors of said vehicles, body conditions of said vehicles, captured partial image data of said vehicles, captured full image data of said vehicle.

19. The computer-usable tangible storage device of claim 17, wherein successful said absolute vehicle identifications of said vehicles comprise absolute vehicle identifications with a confidence level above a pre-defined confidence threshold.

20. The computer-usable tangible storage device of claim 17, wherein using signature matching to pair said vehicles entering said toll road and said vehicles exiting said toll road for some or all remaining unpaired vehicle further comprises at least one of:
for each signature-matched pair of said vehicles where said absolute vehicle identification was successful for one vehicle of said signature matched pair but unsuccessful for the other vehicle of said signature-matched pair, program instructions to assign the successful absolute vehicle identification to said pair;
for each signature matched pair of said vehicles where said absolute vehicle identification was unsuccessful for both vehicles of said signature-matched pair, program instructions to perform absolute vehicle identifications of said signature-matched pair via human inspection;
for remaining unpaired vehicles where said absolute vehicle identification was unsuccessful, program instructions to assist absolute vehicle identification via human inspection;
program instructions to pair said successful absolute vehicle identifications of said remaining unpaired vehicles; and
prioritizing vehicles for signature matching based on at least one of: relative locations where said vehicles enter said toll road and exit said toll road, the time when said vehicles enter said toll road and exit said toll road, anticipated maximum speed of said vehicles, and anticipated minimum speed of said vehicles.
